(19) United States
(12) Patent Application Publication
(10) Pub. No.: US 2011/0320837 A1
(43) Pub. Date: Dec. 29, 2011

(54) POWER SUPPLY CIRCUIT, POWER SUPPLY METHOD, AND SIGNAL PROCESSING APPARATUS

(75) Inventor: Toshinari SUEMATSU, Saitama (JP)

(73) Assignee: Sony Corporation, Tokyo (JP)

(21) Appl. No.: 13/160,837

(22) Filed: Jun. 15, 2011

(30) Foreign Application Priority Data
Jun. 23, 2010 (JP) P2010-142865

(51) Int. Cl. G06F 1/26

(52) U.S. Cl. 713/320

(57) ABSTRACT

A power supply circuit connected to an information processor including first and second controllers via a first cable having a first signal line and a first power line and a second cable having a second signal line and a second power line includes a controller that operates using a current of a first level supplied via the second power line and that performs setup by communicating with the second controller via the second signal line and a switch circuit that supplies, to an external device controller, currents supplied via the first and second power lines. When setup of the external device controller is completed through communication between the external device controller and the first controller via the first signal line, the switch circuit supplies, to the external device controller, a current of a second level higher than the first level supplied via each of the first and second power lines.

### BACKGROUND

The present disclosure relates to a power supply circuit, a power supply method, and a signal processing apparatus and, in particular, to a power supply circuit, a power supply method, and a signal processing apparatus capable of supplying the power necessary for an external device to stably operate from the information processing apparatus while keeping the specification of standard for connecting the external device to an information processing apparatus.

A variety of devices that function as peripheral equipment connected over a universal serial bus (USB) connection (USB devices) have been developed.

Some USB devices operate by receiving electrical power from a personal computer (PC) via a USB cable (bus-powered USB devices). Examples of bus-powered USB devices include not only devices that operate with a relatively low consumption current, such as a mouse and a portable music player, but also devices that operate with a relatively high consumption current, such as an optical disk drive (ODD).

The specification of USB bus power is described next.

A USB cable has four lines: VBUS, GND, D+, and D−. In order to supply power to a bus-powered USE device, VBUS and GND are used. By using D+ and D−, a differential signal is communicated. Thus, data communication between a PC and a USB device is realized.

When a USB plug is plugged into a USB port of a PC and a USB device is connected to the PC, a voltage of 4.75 V to 5.25 V is applied to the USB device. Thus, an electric current of 100 mA is supplied to the USB device. A USB IC of the USB device serving as a target controller operates using the electric current of 100 mA supplied from the PC and sets up configuration between the target controller and a USB IC of the PC serving as a host controller.

In the configuration setup, parameters are communicated between the target controller and the host controller. Thus, a variety of settings are established in both the controllers. For example, information regarding a consumption current necessary for the USB device to operate is transmitted from the target controller to the host controller.

After the configuration setup is completed, an electric current necessary for the USB device to operate is supplied from the PC to the USB device under the control of the host controller. For example, when the USB device is a high-power bus powered device, an electric current of 500 mA is supplied. Upon receiving the electric current of 500 mA, the USB device can drive some hardware in addition to the target controller.

Japanese Unexamined Patent Application Publication No. 2002-297269 describes the related art.

### SUMMARY

Some USB devices consume an electric current of more than 500 mA. A problem arises if such USB devices operate on bus power. According to the USB (USB 2.0) standard, an electric current that can be supplied using a single USB cable is limited to a maximum of 500 mA.

The behavior occurring when the consumption current exceeds 500 mA depends on the design of a host controller. For example, a host controller stops supplying an electric current, restricts the consumption current, or supplies an electric current higher than 500 mA.

If a host controller stops supplying an electric current, the operation of a USB device is stopped. If a host controller restricts the consumption current, the operation of a USB device becomes unstable. If a host controller supplies an electric current higher than 500 mA, a PC or a USB device may malfunction.

Accordingly, in order to allow a USB device that consumes the consumption current of higher than 500 mA to operate on bus power, a variety of techniques are employed or proposed. One of the techniques is to use a Y cable. The external view of a Y cable is shown in FIG. 1A.

As shown in FIG. 1A, a Y cable includes two cables extending from a single plug. Each of the two cables has a plug at the end. One of the plugs on the right in FIG. 1A is plugged into a USB port of a USB device, and the two plugs on the left are plugged into two USB ports of the PC.

When such a Y cable is used for connection, a PC does not supply 500 mA using each cable (a total of 1 A). According to the USB specification, one of the cables connected to the PC can supply up to 500 mA, and the other cable can supply up to 100 mA.

That is, when a USB device is connected to a PC using a Y cable shown in FIG. 1A, the PC can supply an electric current of up to 600 mA in total. Accordingly, although about 1 A is necessary for a USB device such as an ODD to stably operate, it is difficult for a PC to supply a sufficient electric current to the ODD.

Alternatively, in order to allow a USB device that consumes the consumption current of higher than 500 mA to operate on bus power, a DC jack provided on the USB device may be used. FIG. 1B illustrates an ODD connected in this manner.

As shown in FIG. 1B, an ODD is connected to a PC using two cables. The cable located on the upper side of FIG. 1B is a normal USB cable having USB plugs at either end. One of the USB plugs is plugged into a USB port of the ODD, and the other USB plug is plugged into a USB port of the PC. If the configuration is set between the host controller and the target controller in the above-described manner, an electric current of 500 mA is supplied from the PC to the ODD.

In contrast, the cable located on the lower side of FIG. 1B has a USB plug at one end and a DC plug on the other end. The USB plug is plugged into a USB port of the PC, and the DC plug is plugged into a DC jack of the ODD. The configuration is not set for the lower cable. Accordingly, an electric current supplied from the PC to the ODD using the lower cable is 100 mA.

That is, even when such a connection method is used, an electric current suppliable from a PC to a USB device is up to 600 mA. That is, it is difficult to supply a sufficient electric current necessary for an ODD to stably operate.

Accordingly, the present disclosure allows an information processing apparatus to supply electrical power necessary for an external device to reliably operate while keeping the specification of the standard for connecting an external device to an information processing apparatus.

According to an embodiment of the present disclosure, a power supply circuit connected to an information processing apparatus including a first controller and a second controller via a first cable including a first signal line and a first power supply line and a second cable including a second signal line and a second power supply line is provided. The power supply circuit includes a control circuit configured to start operating using an electric current of a first level supplied from the information processing apparatus via the second power supply line and set up settings of the operation by communicating with the second controller via the second signal line and a switch circuit configured to supply, to a controller of an external device, the electric current supplied from the information processing apparatus via the first power supply line and an electric current supplied from the second power supply line when the setup of settings of the operation of the control circuit is completed. When setup of settings of an operation of the controller of the external device is completed through communication between the controller of the external device that has started operating when receiving the electric current and the first controller via the first signal line, the switch circuit supplies, to the controller of the external device, an electrical current of a second level that is higher than the first level supplied from the information processing apparatus via each of the first power supply line and the second power supply line together.

Each of the first cable and the second cable can be a USB compliant cable.

When the first and second controllers of the information processing apparatus, the control circuit, and the controller of the external device are USB controllers that comply with the USB 2.0 standard, the first level can be 100 mA and the second level can be 500 mA. When the first and second controllers of the information processing apparatus, the control circuit, and the controller of the external device are USB controllers that comply with USB 3.0 Super Speed standard, the first level can be 150 mA and the second level can be 900 mA.

The power supply circuit can be provided outside the external device. In such a case, a third cable including the first signal line and a third power supply line used by the switch circuit to supply electrical power can be further connected to the power supply circuit.

According to another embodiment of the present disclosure, a power supply method for use in a power supply circuit is provided. The power supply circuit is connected to an information processing apparatus including a first controller and a second controller via a first cable including a first signal line and a first power supply line and a second cable including a second signal line and a second power supply line. The power supply circuit includes a control circuit configured to start operating using an electric current of a first level supplied from the information processing apparatus via the second power supply line and set up settings of the operation by communicating with the second controller via the second signal line and a switch circuit configured to supply, to a controller of an external device, an electric current supplied from the information processing apparatus via the first power supply line and the second power supply line when the setup of settings of the operation of the control circuit is completed. The method includes, when setup of settings of an operation of the controller of the external device is completed through communication between the controller of the external device that has started operating when receiving the electric current and the first controller via the first signal line, supplying, from the switch circuit to the controller of the external device, an electrical current of a second level that is higher than the first level supplied from the information processing apparatus via each of the first power supply line and the second power supply line together.

According to still another embodiment of the present disclosure, a signal processing apparatus connected to an information processing apparatus including a first controller and a second controller via a first cable including a first signal line and a first power supply line and a second cable including a second signal line and a second power supply line is provided. The signal processing apparatus includes a first control circuit connected to the first controller via the first signal line, a second control circuit configured to start operating using an electric current of a first level supplied from the information processing apparatus via the second power supply line and set up settings of the operation by communicating with the second controller via the second signal line, a switch circuit configured to supply, to the first control circuit, electric currents supplied from the information processing apparatus via the first power supply line and the second power supply line when the setup of settings of the operation of the second control circuit is completed, and a signal processing circuit configured to operate using the electric currents supplied to the first control circuit. The first control circuit starts operating using the electric currents supplied from the switch circuit and sets up settings of the operation through communication with the first controller via the first signal line, and when setup of the settings of the operation of the first control circuit is completed, the switch circuit supplies, to the first control circuit, an electrical current of a second level that is higher than the first level supplied via each of the first power supply line and the second power supply line together.

The first control circuit can communicate with the first controller via the first signal line and receive data transmitted from the first controller and to be processed by the signal processing circuit, and the first control circuit can transmit the data processed by the signal processing circuit to the first controller.

According to yet still another embodiment of the present disclosure, a power supply method for use in a signal processing apparatus is provided. The signal processing apparatus is connected to an information processing apparatus including a first controller and a second controller via a first cable including a first signal line and a first power supply line and a second cable including a second signal line and a second power supply line. The signal processing apparatus includes a first control circuit connected to the first controller via the first signal line, a second control circuit configured to start operating using an electric current of a first level supplied from the information processing apparatus via the second power supply line and set up settings of the operation by communicating with the second controller via the second signal line, a switch circuit configured to supply, to the first control circuit, electric currents supplied from the information processing apparatus via the first power supply line and the second power supply line when the setup of settings of the operation of the second control circuit is completed, and a signal processing circuit configured to operate using the electric currents supplied to the first control circuit. The method includes starting the first control circuit to operate using the electric currents supplied from the switch circuit and set up the operation through communication with the first controller via the first signal line, and when setup of the settings of the operation of the first control circuit is completed, supplying, from the switch circuit to the first control circuit, an electrical current of a second level that is higher than the first level via each of the first power supply line and the second power supply line together.

According to yet still another embodiment of the present disclosure, a signal processing apparatus connected to an information processing apparatus including a first controller and a second controller via a first cable including a first signal line and a first power supply line and a second cable including a second signal line and a second power supply line is provided. The signal processing apparatus includes a first control circuit connected to the first controller via the first signal line, the first control circuit operating using an electric current supplied from the information processing apparatus via the first power supply line, a second control circuit configured to start operating using an electric current of a first level supplied from the information processing apparatus via the second power supply line and set up settings of the operation by communicating with the second controller via the second signal line, a switch circuit configured to output electric currents supplied from the information processing apparatus via the first power supply line and the second power supply line, and a signal processing circuit configured to operate using the electric currents supplied from the switch circuit. When setup of settings of the operation of the second control circuit is completed, the first control circuit starts operating using the electric current supplied from the information processing apparatus via the first power supply line and sets up settings of the operation through communication with the first controller via the first signal line, and when setup of the settings of the operation of the first control circuit is completed, the switch circuit outputs an electric current of a second level higher than the first level that is supplied from the information processing apparatus via the first power supply line and an electrical current of the second level that is supplied from the information processing apparatus via the second power supply line together.

The first control circuit can communicate with the first controller via the first signal line and receive data transmitted from the first controller and to be processed by the signal processing circuit, and the first control circuit can transmit the data processed by the signal processing circuit to the first controller.

According to yet still another embodiment of the present disclosure, a power supply method for use in a signal processing apparatus connected to an information processing apparatus including a first controller and a second controller via a first cable including a first signal line and a first power supply line and a second cable including a second signal line and a second power supply line is provided. The signal processing apparatus includes a first control circuit connected to the first controller via the first signal line and operating using an electric current supplied from the information processing apparatus via the first power supply line, a second control circuit configured to start operating using an electric current of a first level supplied from the information processing apparatus via the second power supply line and set up settings of the operation by communicating with the second controller via the second signal line, a switch circuit configured to output the electric currents supplied from the information processing apparatus via the first power supply line and the second power supply line, and a signal processing circuit configured to operate using the electric currents supplied from the switch circuit. The method includes, when setup of settings of the operation of the second control circuit is completed, starting the first control circuit to operate using the electric current supplied from the information processing apparatus via the first power supply line and setting up the operation through communication with the first controller via the first signal line and, when setup of the settings of the operation of the first control circuit is completed, outputting, from the switch circuit, an electric current of a second level higher than the first level that is supplied from the information processing apparatus via the first power supply line and an electrical current of the second level that is supplied from the information processing apparatus via the second power supply line together.

According to the embodiment of the present disclosure, the controller of the external device that has started operating when an electric current was supplied communicates with the first controller using the first signal line. In this way, when setup of the settings of the operation of the controller of the external device is completed, an electrical current of a second level that is higher than the first level supplied from the information processing apparatus via each of the first power supply line and the second power supply line is supplied to the controller of the external device together.

According to the embodiment of the present disclosure, the first control circuit starts operating using an electrical current supplied from the switch circuit and communicates with the first controller using the first signal line. Thus, settings of the operation are set up. In addition, when setup of settings of the operation performed by the first control circuit is completed, an electrical current of the second level is supplied to the first control circuit via each of the first power supply line and the second power supply line together.

According to the embodiment of the present disclosure, when setup of settings of the operation performed by the second control circuit is completed, the first control circuit starts operating using an electrical current supplied from the information processing apparatus via the first power supply line, and the first control circuit communicates with the first controller via the first signal line. Thus, setup of settings of the operation is performed. In addition, when setup of the settings of the operation is completed, an electric current of a second level higher than the first level that is supplied from the information processing apparatus via the first power supply line and an electrical current of the second level that is supplied from the information processing apparatus via the second power supply line are output together.

According to the embodiments of the present disclosure, an information processing apparatus can supply, to an external device, the power necessary for the external device to stably operate while keeping the specification of standard for connecting an external device to an information processing apparatus.

### BRIEF DESCRIPTION OF THE DRAWINGS

FIGS. 1A and 1B illustrate examples of a cable used for connection between a PC and an ODD;

FIG. 2 illustrates an example of connection between a PC and an ODD;

FIG. 3 illustrates an example of electrical connection among circuits when an ODD is connected to a PC as shown in FIG. 2;

FIG. 4 is a flowchart of a power supply operation;

FIG. 5 is a flowchart of another power supply operation;

FIG. 6 illustrates an example in which an AC adaptor is connected;

FIG. 7 illustrates an example of connection between a PC and an ODD;

FIG. 8 illustrates an example of connection between a PC and an ODD;

FIG. 9 illustrates an example of connection between a PC and an ODD;

FIG. 10 illustrates an example of connection between a PC and an ODD;

FIG. 11 illustrates an example of connection between a PC and an ODD;

FIG. 12 illustrates an example of connection between a PC and an ODD;

FIG. 13 illustrates an example of electrical connection among circuits when an ODD is connected to a PC in a manner shown in FIG. 12;

FIG. 14 illustrates an example of connection when an AC adaptor is connected;

FIG. 15 illustrates an example of connection between a PC and an ODD;

FIG. 16 illustrates an example of connection between a PC and an ODD;

FIG. 17 illustrates an example of electrical connection among circuits when an ODD is connected to a PC in a manner shown in FIG. 16;

FIG. 18 is a flowchart of a power supply operation;

FIG. 19 illustrates an example of connection when an AC adaptor is connected;

FIG. 20 illustrates an example of connection between a PC and an ODD; and

FIG. 21 illustrates an example of electrical connection among circuits when an ODD is connected to a PC in a manner shown in FIG. 20.

### DETAILED DESCRIPTION OF EMBODIMENTS

### First Embodiment

### Configurations of Units

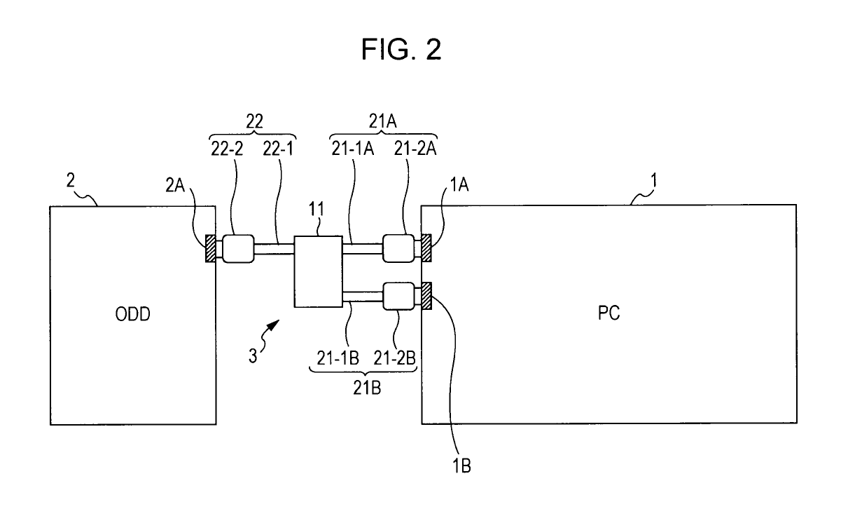

FIG. 2 illustrates an example of connection between apparatuses using a Y cable according to an embodiment the present disclosure.

As shown in FIG. 2, a PC 1 is connected to an ODD 2 using a Y cable 3. The Y cable 3 includes a connection unit 11. The Y cable 3 is formed by connecting USB cables 21A and 21B to one side of the connection unit 11 and connecting a USB cable 22 to the other side of the connection unit 11.

Each of the USB cables 21A, 21B, and 22 includes the following four lines: VBUS, GND, D+, and D−. A power supply line is formed from VBUS and GND. A signal line is formed from D+ and D−.

One end of the USB cable 21A is directly connected to the connection unit 11. The USB cable 21A includes a cable 21-1A and a plug 21-2A attached to a top end of the cable 21-1A. The plug 21-2A is plugged into a USB port 1A of the PC 1.

One end of the USB cable 21B is directly connected to the connection unit 11. The USB cable 21B includes a cable 21-1B and a plug 21-2B attached to a top end of the cable 21-1B. The plug 21-2B is plugged into a USB port 1B of the PC 1.

One end of the USB cable 22 is directly connected to the connection unit 11. The USB cable 22 includes a cable 22-1 and a plug 22-2 attached to a top end of the cable 22-1. The plug 22-2 is plugged into a USB port 2A of the ODD 2.

The ODD 2 is connected to the PC 1 using the Y cable 3 having such a configuration. The ODD 2 serves as a bus-powered USB device that operates using electrical power supplied from the PC 1 via the Y cable 3. In order for the ODD 2 to stably operate, an electrical power of about 5 V×1 A is necessary. The consumption current is about 1 A.

An electric current of 1 A is supplied from the PC 1 to the ODD 2 via the Y cable 3. In the ODD 2, each of hardware components is driven by the electric current supplied from the PC 1. Thus, data sent from the PC 1 is written onto an optical disc, such as a Blu-ray (trade name) disc or a digital versatile disc (DVD), or data is read from an optical disc and is transmitted to the PC 1.

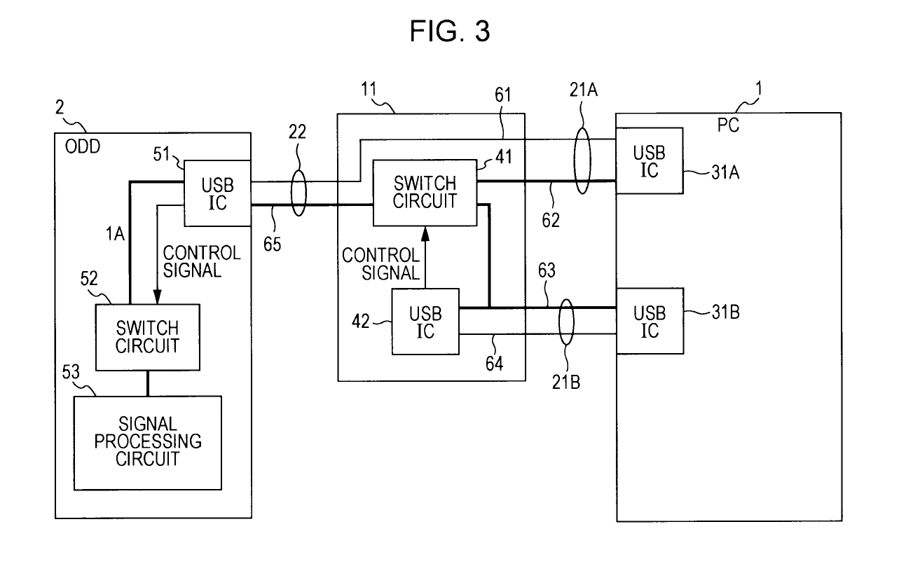

FIG. 3 illustrates an example of electrical connection among circuits.

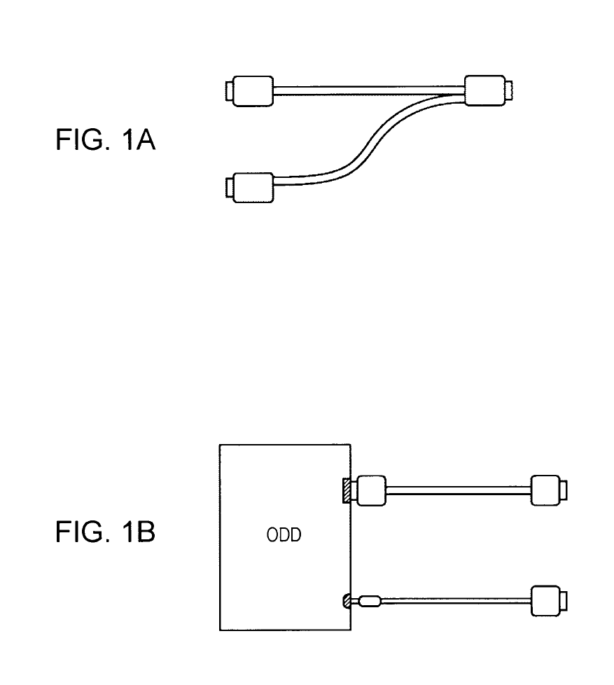

As shown in FIG. 3, the PC 1 includes a USB IC 31A for controlling communication performed in the USB port 1A shown in FIG. 1A and a USB IC 31B for controlling communication performed in the USB port 1B shown in FIG. 1B.

The ODD 2 includes a USB IC 51 for controlling communication performed in the USB port 2A, a switch circuit 52, and a signal processing circuit 53. The signal processing circuit 53 includes a variety of hardware components, such as a motor that rotates an optical disc mounted in the ODD 2 and a laser and a pickup used for reading and writing data.

The connection unit 11 of the Y cable 3 includes a switch circuit 41 and a USB IC 42.

As illustrated in FIGS. 1A and 1B, when the ODD 2 is connected to the PC 1 using the Y cable 3, the USB IC 31A of the PC 1 is connected to the USB IC 51 of the ODD 2 via a signal line 61 that extends through the USB cable 21A and the USB cable 22. A signal line that forms the USB cable 21A and a signal line that forms the USB cable 22 are connected and form a single line.

The USB IC 31A of the PC 1 functions as a host controller of the USB IC 51 of the ODD 2 connected using the signal line 61. The USB IC 51 of the ODD 2 functions as a target controller of the USB IC 31A of the PC 1.

In addition, as shown in FIG. 3, the USB IC 31A of the PC 1 is connected to the switch circuit 41 of the connection unit 11 using a power supply line 62 that extends through the USB cable 21A.

The USB IC 31B of the PC 1 is connected to the switch circuit 41 of the connection unit 11 using a power supply line 63 that extends through the USB cable 21B. The switch circuit 41 of the connection unit 11 receives an electric current output from the USB IC 31A of the PC 1 to the power supply line 62. In addition, the switch circuit 41 receives an electric current output from the USB IC 31B of the PC 1 to the power supply line 63 (an electric current that branches in the power supply line 63 and that does not include a current consumed by the USB IC 42).

The power supply line 63 in the USB cable 21B branches inside the connection unit 11. One of the branches is connected to the switch circuit 41, and the other branch is connected to the USB IC 42. The USB IC 31B of the PC 1 is connected to the USB IC 42 of the connection unit 11 using the power supply line 63 and a signal line 64 that extend through the USB cable 21B.

The USB IC 31B of the PC 1 functions as a host controller for the USB IC 42 of the connection unit 11 connected using the signal line 64. The USB IC 42 of the connection unit 11 functions as a target controller of the USB IC 31B of the PC 1. In the connection unit 11, the switch circuit 41 is connected to the USB IC 42. Thus, the USB IC 42 can supply a control signal to the switch circuit 41.

The switch circuit 41 of the connection unit 11 is connected to the USB IC 51 of the ODD 2 using a power supply line 65 that extends through the USB cable 22. The switch circuit 41 of the connection unit 11 controls supply of an electric current output from the USB IC 31A of the PC 1 and an electric current output from the USB IC 31B of the PC 1 to the USB IC 51 of the ODD 2. The connection unit 11 functions as a power supply circuit for the ODD 2. The switch circuit 41 of the connection unit 11 functions as a circuit that switches supply of an electric current to the ODD 2.

In the ODD 2, the USB IC 51 is connected to the switch circuit 52. An electric current supplied to the USB IC 51 via the power supply line 65 is supplied from the USB IC 51 to the switch circuit 52. In addition, the switch circuit 52 is connected to the signal processing circuit 53. The electric current supplied from the USB IC 51 to the switch circuit 52 is supplied to the signal processing circuit 53 in accordance with the operation performed by the switch circuit 52.

### Operation of Each Unit

The operation of each of the units connected in the above-described manner is described below.

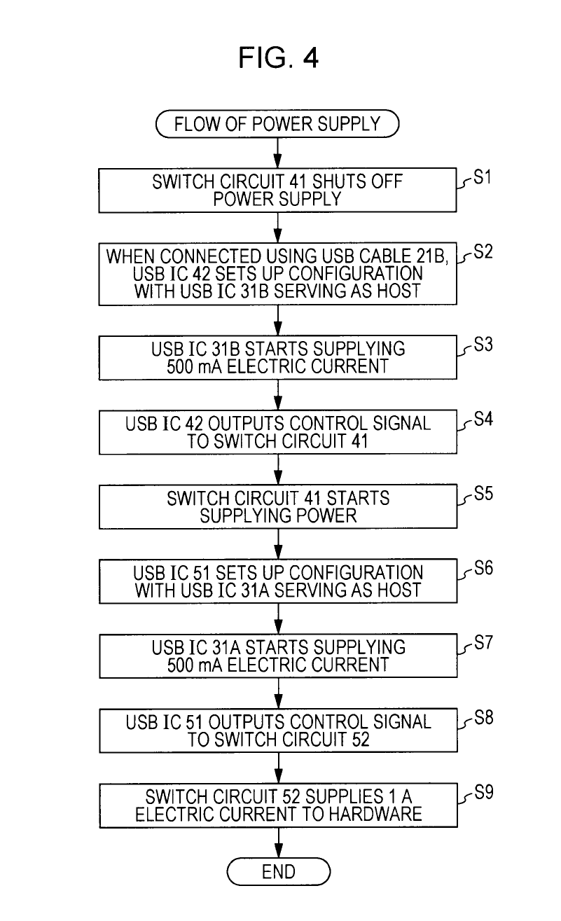

The operation performed when the plug 21-2A of the USB cable 21A is plugged into the USB port 1A of the PC 1 first and, thereafter, the plug 21-2B of the USB cable 21B is plugged into the USB port 1B of the PC 1 is described with reference to a flowchart shown in FIG. 4. Note that the plug 22-2 of the USB cable 22 has already been plugged into the USB port 2A of the ODD 2.

In step S1, when the connection unit 11 is connected to the PC 1 using the USB cable 21A, the switch circuit 41 does not operate until the connection unit 11 is connected to the PC 1 using the USB cable 21B. When the connection unit 11 is connected to the PC 1 using the USB cable 21A, an electric current of 100 mA is supplied from the USB IC 31A to the switch circuit 41 via the power supply line 62. However, since the switch circuit 41 does not operate, supply of power from the PC 1 to the ODD 2 is continuously shut off.

In step S2, when the PC 1 is connected to the connection unit 11 using the USB cable 21B, the USB IC 42 of the connection unit 11 starts operating due to an electric current of 100 mA (an electric current before configuration is set up) supplied from the USB IC 31B of the PC 1 via the power supply line 63. The USB IC 42 sets up configuration between the USB IC 42 and the USB IC 31B that serves as a host controller of the USB IC 42 while communicating with the USB IC 31B via the signal line 64.

When configuration setup is completed between the USB IC 31B and the USB IC 42 and if the USB IC 31B recognizes that the USB IC 42 of the connection unit 11 is a high-power bus powered device, the USB IC 31B of the PC 1, in step S3, starts supplying an electric current of 500 mA. Part of the electric current of 500 mA supplied from the USB IC 31B of the PC 1 via the power supply line 63 is supplied to the USB IC 42, and the other is supplied to the switch circuit 41. For example, when the consumption current of the USB IC 42 is 10 mA, a current of 490 mA is supplied to the switch circuit 41.

At that time, since an electric current consumed by the USB IC 42 is very small, the electric current is negligible. Similarly, an electric current consumed by the USB IC 51 of the ODD 2 is negligible.

In step S4, the USB IC 42 of the connection unit 11 outputs a control signal to the switch circuit 41.

In step S5, upon receiving the control signal supplied from the USB IC 42, the switch circuit 41 of the connection unit 11 starts supplying power to the ODD 2.

At that time, the switch circuit 41 may determine whether power is supplied from both the power supply lines 62 and 63 and start supplying electrical power to the ODD 2. It can be determined whether power is supplied from the power supply line by measuring the voltage, in general. In this way, the situation in which power is supplied to the ODD 2 although power is supplied from only one of the power supply lines 62 and 63 can be avoided.

An electric current of 100 mA supplied from the USB IC 31A of the PC 1 via the power supply line 62 and an electric current of 500 mA supplied from the USB IC 31B via the power supply line 63 are supplied to the USB IC 51 of the ODD 2 via the power supply line 65. The USB IC 51 of the ODD 2 starts operating in response to the electric current supplied via the power supply line 65.

Note that supply of the electric current supplied from the USB IC 31B via the power supply line 63 may be stopped until setup of configuration between the USB IC 51 of the ODD 2 and the USB IC 31A of the PC 1 is completed.

In step S6, the USB IC 51 of the ODD 2 sets up configuration between the USB IC 51 and the USB IC 31A of the PC 1 that serves as a host controller of the USB IC 51 while communicating with the USB IC 31A via the signal line 61.

When configuration setup is completed between the USB IC 51 and the USB IC 31A and if the USB IC 31A recognizes that the USB IC 51 of the ODD 2 functions as a high-power bus powered device, the USB IC 31A of the PC 1, in step S7, starts supplying an electric current of 500 mA.

In addition to the 500 mA electric current already supplied from the USB IC 31B, a 500 mA electric current supplied from the USB IC 31A (1 A in total) is output from the switch circuit 41 of the connection unit 11 to the USB IC 51 of the ODD 2. The electric current is supplied via the power supply line 65. The electric current supplied to the ODD 2 is supplied from the USB IC 51 to the switch circuit 52. However, the switch circuit 52 shuts off supply of an electric current until it receives a control signal from the USB IC 51. At this point in time, the signal processing circuit 53 does not start operating.

In step S8, the USB IC 51 of the ODD 2 outputs a control signal to the switch circuit 52.

In step S9, upon receiving the control signal from the USE IC 51, the switch circuit 52 of the ODD 2 starts supplying electrical power to the signal processing circuit 53. In this way, the signal processing circuit 53 starts receiving a 500 mA electric current from the USB IC 31A of the PC 1 and a 500 mA electric current from the USB IC 31B of the PC 1 (a 1 A electric current in total).

The signal processing circuit 53 starts operating using the 1 A electric current supplied from the switch circuit 52 and reads data from or writes data to an optical disc. Data to be written to an optical disc is supplied from the USB IC 31A of the PC 1 to the USB IC 51 via the signal line 61 and, thereafter, is supplied to the signal processing circuit 53 via a signal line (not shown). In contrast, data read from an optical disc is supplied from the signal processing circuit 53 to the USB IC 51 via a signal line (not shown) and is supplied to the USB IC 31A of the PC 1 via the signal line 61.

That is, in this example, like a widely used USB-connected ODD, the USB IC 51 operates as a mass storage class (MSC) device. In contrast, the USB IC 42 operates as a device for receiving electrical power. Data to be written to an optical disc and data read from an optical disc are not exchanged between the USE IC 31B of the PC 1 and the USB IC 51 of the ODD 2.

As described above, by using the Y cable 3 for connection, the ODD 2 can receive a 500 mA electric current from each of the USB IC 31A and the USB IC 31B of the PC 1 (a 1 A electric current in total). Thus, the ODD 2 can stably operate.

In addition, the switch circuit 41 of the connection unit 11 and the switch circuit 52 of the ODD 2 function as a “stopper”. Accordingly, an electric current is not supplied to the signal processing circuit 53 until the PC 1 starts supplying a 1 A electric current. In this way, the signal processing circuit 53 does not start operating when the electric current is insufficient. Thus, the signal processing circuit 53 can reliably perform reading and writing data.

Furthermore, in the case of a Y cable shown in FIG. 1A, since two cables extend from one plug, a back current may flow from one of the USB ports of a PC to the other USB port. The switch circuit 41 can be configured so that such a back current is prevented.

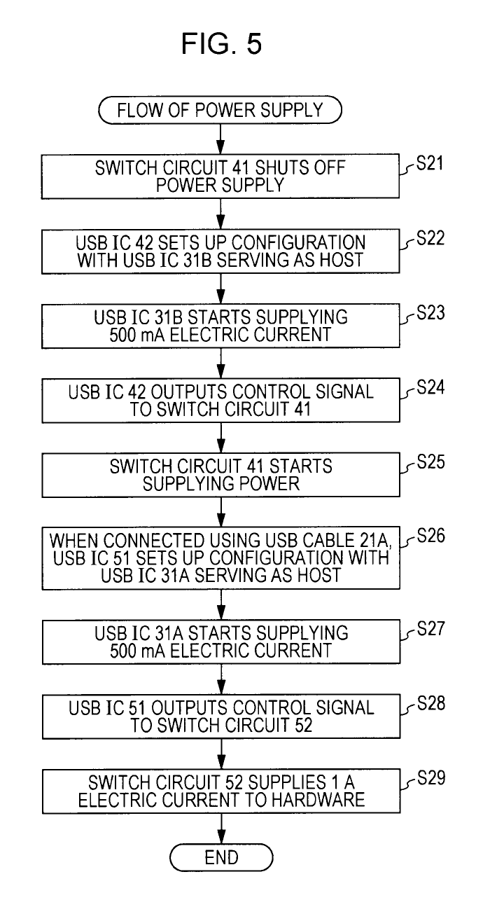

The operation performed when the plug 21-2B of the USB cable 21B is plugged into the USB port 1B of the PC 1 first and, thereafter, the plug 21-2A of the USB cable 21A is plugged into the USB port 1A of the PC 1 is described with reference to a flowchart shown in FIG. 5. Note that like the above-described case, the plug 22-2 of the USB cable 22 has already been plugged into the USB port 2A of the ODD 2.

In step S21, the switch circuit 41 shuts off supply of power to the ODD 2.

When the PC 1 is connected to the connection unit 11 using the USB cable 21B, the USB IC 42 of the connection unit 11 starts operating due to a 100 mA electric current supplied from the USB IC 31B of the PC 1 via the power supply line 63. In step S22, the USB IC 42 sets up configuration between the USB IC 42 and the USB IC 31B that serves as a host controller of the USB IC 42 while communicating with the USB IC 31B via the signal line 64.

When the connection unit 11 is connected to the PC 1 using the USB cable 21B, a 100 mA electric current is supplied from the USB IC 31B to the switch circuit 41 via the power supply line 63. However, since the switch circuit 41 does not operate, supply of electrical power from the PC 1 to the ODD 2 continues to be shut off.

When configuration setup between the USB IC 42 and the USB IC 31B is completed and if the USB IC 31B recognizes that the USB IC 42 of the connection unit 11 is a high-power bus powered device, the USB IC 31B of the PC 1, in step S23, starts supplying an electric current of 500 mA. The electric current of 500 mA supplied from the USB IC 31B of the PC 1 via the power supply line 63 is supplied to the switch circuit 41.

In step S24, the USB IC 42 of the connection unit 11 outputs a control signal to the switch circuit 41.

In step S25, upon receiving the control signal from the USB IC 42, the switch circuit 41 of the connection unit 11 starts supplying electrical power to the ODD 2. The 500 mA electric current supplied from the USB IC 31B via the power supply line 63 is supplied to the USB IC 51 of the ODD 2 via the power supply line 65. At that time, the switch circuit 41 may stop supplying power to the ODD 2 until the switch circuit 41 determines that power (a voltage) is supplied from each of the power supply lines 62 and 63.

In step S26, when the connection unit 11 is connected to the PC 1 via the USB cable 21A, the USB IC 51 of the ODD 2 starts operating using the electric current supplied via the power supply line 65. The USB IC 51 communicates with the USB IC 31A that functions as a host controller of the USB IC 51 via the signal line 61 and sets up configuration with the USB IC 31A.

When configuration setup between the USB IC 31A of the PC 1 and the USB IC 51 of the ODD 2 is completed and if the USB IC 31A recognizes that the USB IC 51 is a high-power bus powered device, the USB IC 31A of the PC 1, in step S27, starts supplying an electric current of 500 mA.

In addition to the electric current of 500 mA already supplied from the USB IC 31B of the PC 1, the electric current of 500 mA supplied from the USB IC 31A is output from the switch circuit 41 of the connection unit 11 (i.e., an electric current of 1 A is output in total). This electric current is supplied to the USB IC 51 of the ODD 2 via the power supply line 65. The electric current supplied to the ODD 2 is supplied from the USB IC 51 to the switch circuit 52. However, the switch circuit 52 shuts off supply of the electric current until it receives a control signal from the USB IC 51. At this point in time, the signal processing circuit 53 does not start operating.

In step S28, the USB IC 51 of the ODD 2 outputs a control signal to the switch circuit 52.

In step S29, upon receiving the control signal from the USB IC 51, the switch circuit 52 of the ODD 2 starts supplying electrical power to the signal processing circuit 53. Thus, supply of a 500 mA electric current is started from each of the USB IC 31A and the USB IC 31B of the PC 1 to the signal processing circuit 53 (i.e., a 1 A electric current in total).

In this way, even when either the USB cable 21A or the USB cable 21B of the Y cable 3 is connected to the PC 1 first, a 1 A electric current can be supplied to the ODD 2.

### Modifications

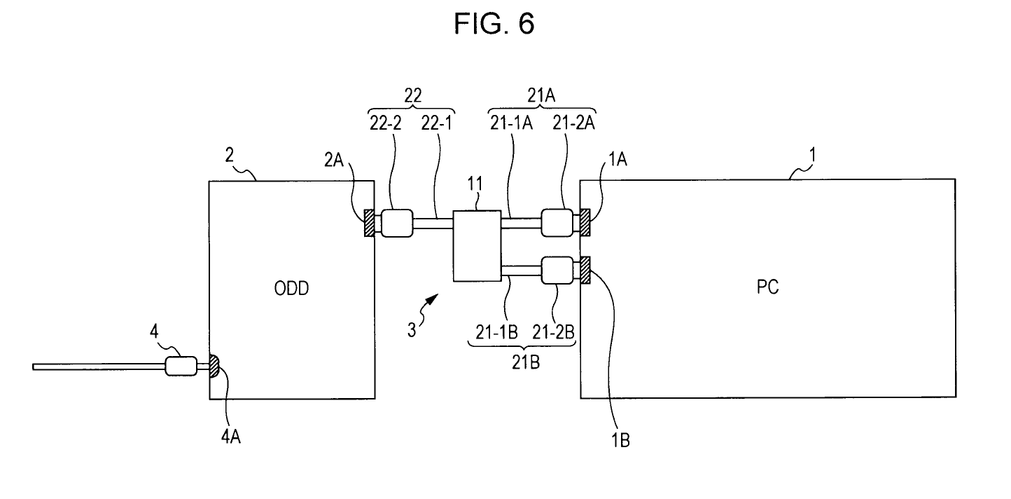

FIG. 6 illustrates an example in which an AC adaptor is connected.

In the example shown in FIG. 6, by using a technique that is the same as that shown in FIG. 2, the ODD 2 is connected to the PC 1 via the Y cable 3. A DC plug 4 is plugged into a DC jack 4A of the ODD 2. An electric current output from an AC adaptor (not shown) is supplied to the ODD 2.

In the case in which the ODD 2 is connected to the PC 1 via the Y cable 3 and the ODD 2 operates using a 1 A electric current supplied from the PC 1 in the above-described manner, if, as shown in FIG. 6, the DC plug 4 is plugged into the DC jack 4A, the ODD 2 starts operating in a self-powered mode. In a self-powered mode, the ODD 2 can acquire electrical power necessary for the operation from the DC plug 4. Thus, for a safety reason, a shut-off circuit (not shown) provided in the ODD 2 shuts off electrical power supplied to the USB port 2A from the outside.

That is, the USB IC 51 of the ODD 2 transmits, to the USB IC 31A of the PC 1, information indicating start of a self-powered operation.

Upon receiving the information from the USB IC 51, the USB IC 31A of the PC 1 stops supplying a 500 mA electric current to the power supply line 62. The USB IC 31B of the PC 1 continues a predetermined operation performed with the USB IC 42. Thus, the output from the switch circuit 41 also continues. However, since the ODD 2 operates in a self-powered mode, electrical power through the power supply line 65 is not consumed, and the electric current consumed through the power supply line 63 is only the electric current consumed by the USB IC 42.

In this way, supply of power from the PC 1 to the ODD 2 is stopped, and the ODD 2 operates in a self-powered mode. The above description has been made with reference to transition from a bus-powered operation to a self-powered operation occurring when the DC plug 4 is plugged into the DC jack 4A while the ODD 2 is operating in a bus-powered mode. However, if the ODD 2 has already been operating in a bus-powered mode, electrical power supplied from the DC jack 4A may be shut off and the bus-powered operation may be continued.

The operation performed when an AC adaptor is connected to the ODD 2 in the case in which in FIG. 6, the USB cable 22 is connected to the ODD 2 and the USB cables 21A and 21B are not connected to the PC 1 is described below.

Immediately after the DC plug 4 is plugged into the DC jack 4A of the ODD 2, electrical power necessary for the ODD 2 to operate is supplied from the AC adaptor. Upon detecting connection of the AC adaptor, the USB IC 51 of the ODD 2 sets the mode of the ODD 2 to a self-powered mode. When the ODD 2 operates in a self-powered mode, electrical power necessary for the operation can be acquired from the AC adaptor. Therefore, for a safety reason, a shut-off circuit (not shown) provided in the ODD 2 shuts off electrical power supplied to the USB port 2A from the outside.

When the USB cable 21A is connected to the PC 1, the USB IC 51 of the ODD 2 communicates with the USB IC 31A of the PC 1 via the signal line 61 and performs a variety of operations, such as a configuration setup and exchange of a variety of data items after the configuration setup is completed.

In such a case, connection of the USB cable 21B is not necessary. Even when the USB cable 21B is connected to the PC 1 and the switch circuit 41 of the connection unit 11 starts supplying power to the ODD 2, the power supplied to the USB port 2A is shut off by the shut-off circuit in the ODD 2.

As described above, when the ODD 2 operates in a self-powered mode, connection of the USB cable 21B is not necessary. Thus, in order to connect the ODD 2 to the PC 1, a single normal USB cable may be used instead of the Y cable 3.

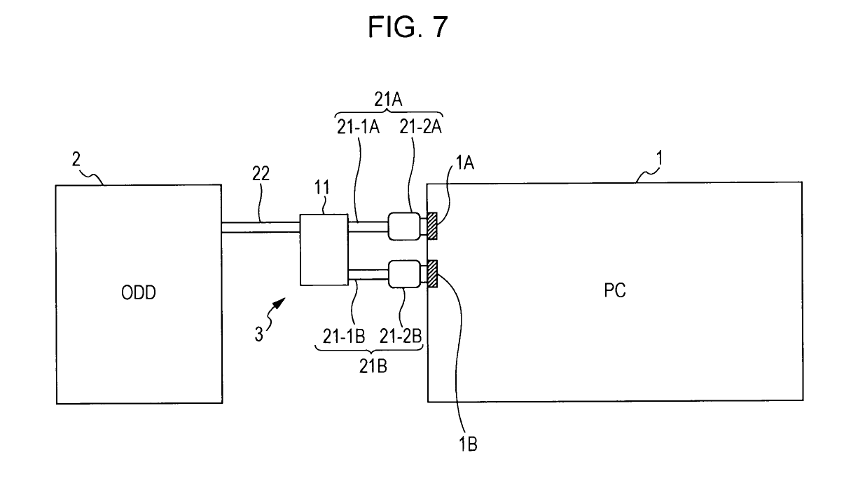

FIG. 7 illustrates another example of connection between the PC 1 and the ODD 2 using the Y cable 3.

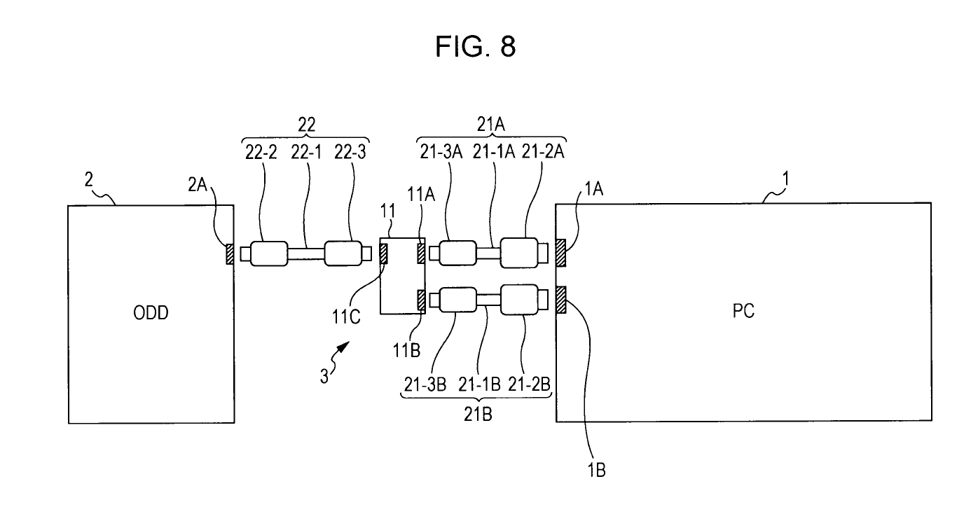

The same numbering will be used in referring to a configuration shown in FIG. 7 as is utilized above in describing FIG. 2. Duplicate descriptions are not repeated as necessary. This also applies to FIGS. 8 to 11. In the example shown in FIG. 7, the Y cable 3 is directly connected to the ODD 2.

When the USB cable 21A shown in FIG. 7 is connected to the PC 1 and, subsequently, the USB cable 21B is connected to the PC 1, supply of a 1 A electric current to the ODD 2 is started, as illustrated in FIG. 4. Alternatively, when the USB cable 21B is connected to the PC 1 and, subsequently, the USB cable 21A is connected to the PC 1, supply of a 1 A electric current to the ODD 2 is started, as illustrated in FIG. 5.

FIG. 8 illustrates still another example of connection between the PC 1 and the ODD 2 using the Y cable 3.

In the example shown in FIG. 8, three USB cables connected to the connection unit 11, namely, the USB cables 21A, 21B, and 22 are removable from the connection unit 11. The USB cable 21A includes the cable 21-1A, the plug 21-2A, and the plug 21-3A. The USB cable 21B includes the cable 21-1B, the plug 21-2B, and the plug 21-3B. The USB cable 22 includes the cable 22-1, the plug 22-2, and the plug 22-3.

The plug 21-3A of the USB cable 21A is plugged into a plug 11A of the connection unit 11. The plug 21-3B of the USB cable 21B is plugged into a plug 11B of the connection unit 11. The plug 22-3 of the USB cable 22 is plugged into a plug 11C of the connection unit 11.

Even when the ODD 2 is connected to the PC 1 as shown in FIG. 8, electrical connection among the circuits are the same as that shown in FIG. 3.

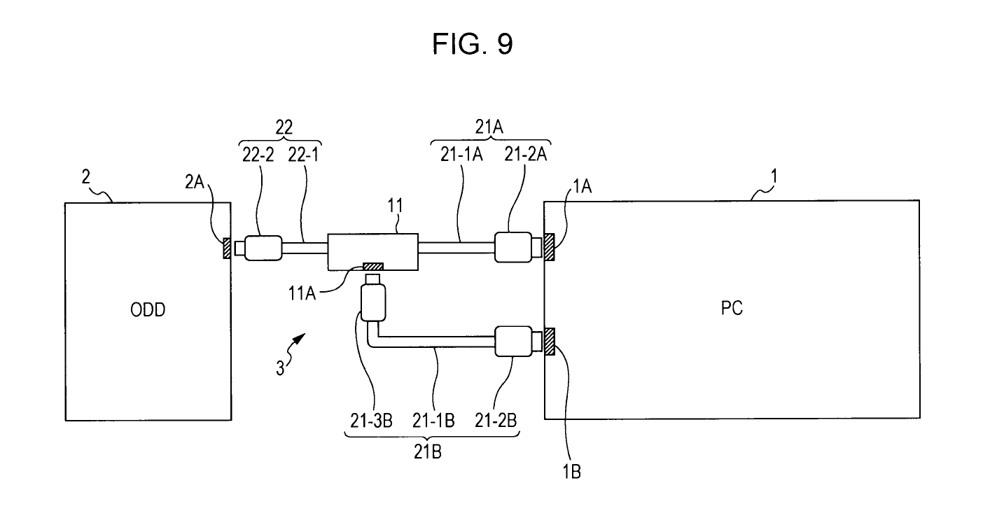

FIG. 9 illustrates yet still another example of connection between the PC 1 and the ODD 2 using the Y cable 3.

In the example shown in FIG. 9, among the USB cables 21A, 21B, and 22 connected to the connection unit 11, only the USB cable 21B is removable from the connection unit 11. The USB cables 21A and 22 are directly connected to the connection unit 11.

The USB cable 21A includes a cable 21-1A having one end directly connected to the connection unit 11 and a plug 21-2A attached to the top end of the cable 21-1A. The USB cable 21B includes a cable 21-1B, a plug 21-2B, and a plug 21-3B. The plug 21-3B of the USB cable 21B is plugged into a plug 11A of the connection unit 11. The USB cable 22 includes a cable 22-1 having one end directly connected to the connection unit 11 and a plug 22-2 attached to the top end of the cable 22-1.

Even when the ODD 2 is connected to the PC 1 as shown in FIG. 9, electrical connection among the circuits are the same as that shown in FIG. 3.

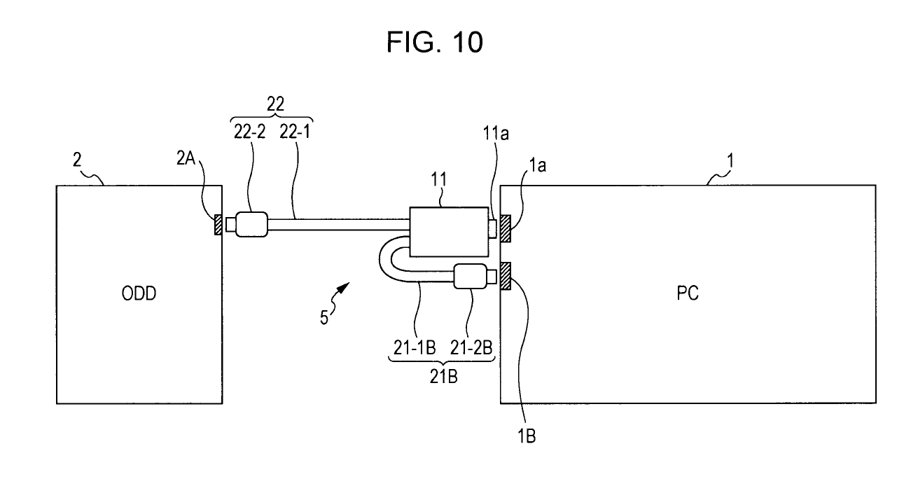

FIG. 10 illustrates an example of connection between the PC 1 and the ODD 2 using a connection cable 5.

As shown in FIG. 10, the connection cable 5 is formed by connecting the USB cables 21B and 22 to the connection unit 11. The connection unit 11 includes a connector 11a in place of the USB cable 21A. The connector 11a is plugged into a connector port 1a provided to the PC 1.

In the example shown in FIG. 10, the USB cables 21B and 22 are directly connected to the connection unit 11. The USB cable 21B includes a cable 21-1B and a plug 21-2B. The USB cable 22 includes a cable 22-1 and a plug 22-2.

Even when the ODD 2 is connected to the PC 1 as shown in FIG. 10, electrical connection among the circuits are the same as that shown in FIG. 3.

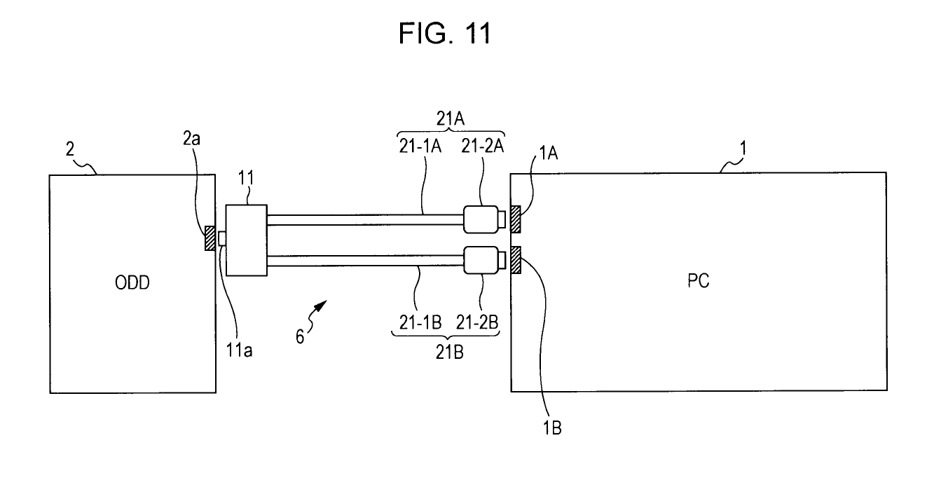

FIG. 11 illustrates an example of connection between the PC 1 and the ODD 2 using a connection cable 6.

In the example shown in FIG. 10, the connector 11a of the connection unit 11 is connected to the PC 1. In contrast, in the example shown in FIG. 11, the connector 11a of the connection unit 11 is connected to the ODD 2.

As shown in FIG. 11, the connection cable 6 is formed by connecting the USB cables 21A and 21B to the connection unit 11. The connection unit 11 includes a connector 11a in place of the USB cable 22. The connector 11a is plugged into a connector port 2a provided to the ODD 2.

In the example shown in FIG. 11, the USB cables 21A and 21B are directly connected to the connection unit 11. The USB cable 21A includes a cable 21-1A and a plug 21-2A. The USB cable 21B includes a cable 21-1B and a plug 21-2B.

Even when the ODD 2 is connected to the PC 1 as shown in FIG. 11, electrical connection among the circuits are the same as that shown in FIG. 3.

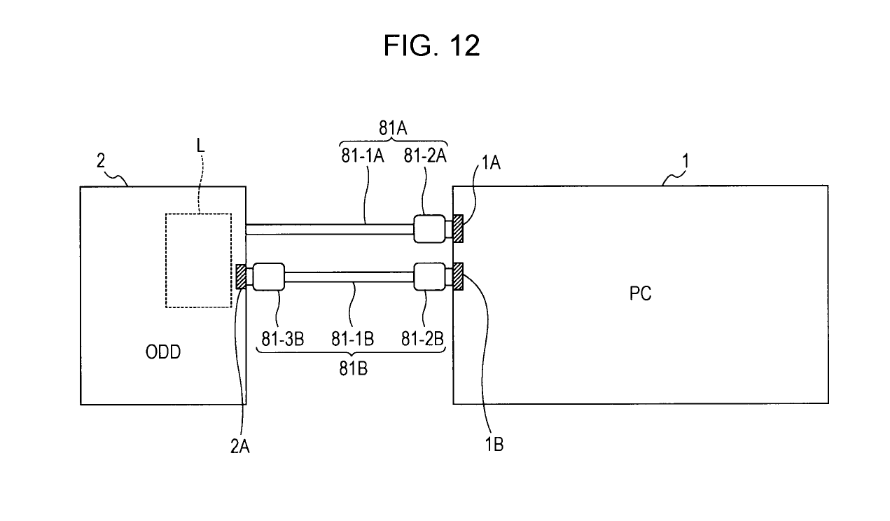

FIG. 12 illustrates yet still another example of connection between the PC 1 and the ODD 2.

In the example shown in FIG. 12, the PC 1 is connected to the ODD 2 using USB cables 81A and 81B.

The USB cable 81A includes a cable 81-1A having one end directly connected to the ODD 2 and a plug 81-2A attached to the top end of the cable 81-1A. The plug 81-2A is plugged into the USB port 1A of the PC 1. Instead of directly mounting the USB cable 81A to the ODD 2, the USB cable 81A may be connected to the ODD 2 by plugging a plug attached to the top end of the USB cable 81A into a USB port of the ODD 2.

The USB cable 81B is formed by providing plugs 81-2B and 81-3B to either end of a cable 81-1B. The plug 81-2B is plugged into the USB port 1B of the PC 1, and the plug 81-3B is plugged into the USB port 2A of the ODD 2. The shape of the plug 81-3B plugged into the USB port 2A of the ODD 2 may be the shape of a widely used B-plug or the shape of a mini B plug, a micro B plug, or a dedicated connector.

In the above-described example, the ODD 2 is connected to the PC 1 using the Y cable 3. However, in the example shown in FIG. 12, the ODD 2 is connected to the PC 1 using two cables, namely, the USB cables 81A and 81B. As indicated by a dotted line L, a circuit similar to the power supply circuit in the connection unit 11 is provided in the ODD 2.

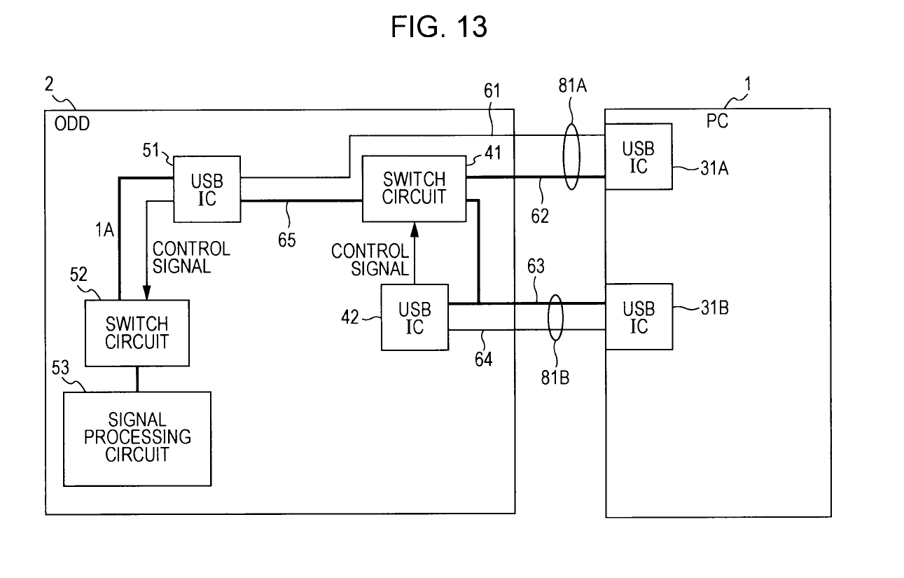

FIG. 13 illustrates an example of electrical connection between the PC 1 and the ODD 2 realized by using two cables, namely, the USB cables 81A and 81B in a manner shown in FIG. 12.

The same numbering will be used in referring to a configuration shown in FIG. 13 as is utilized above in describing FIG. 3. Duplicate descriptions are not repeated as necessary.

As shown in FIG. 13, the USB cable 81A includes a signal line 61 that connects the USB IC 31A of the PC 1 to the USB IC 51 of the ODD 2 and a power supply line 62 that connects the USB IC 31A of the PC 1 to the switch circuit 41 provided in the ODD 2.

The USB cable 81B includes a power supply line 63 and a signal line 64. The power supply line 63 branches in the ODD 2 and connects the USB IC 31B of the PC 1 to each of the switch circuit 41 and the USB IC 42. The signal line 64 connects the USB IC 31B to the USB IC 42.

The operations of the components shown in FIG. 13 are the same as those of the components shown in FIG. 3. That is, when the USB cable 81A shown in FIG. 13 is connected to the PC 1 and, subsequently, the USB cable 81B is connected to the PC 1, supply of a 1 A electric current to the ODD 2 is started, as illustrated in FIG. 4. At that time, the plug 81-3B of the USB cable 81B is plugged into the USB port 2A.

Alternatively, when the USB cable 81B is connected to the PC 1 and, subsequently, the USB cable 81A is connected to the PC 1, supply of a 1 A electric current to the ODD 2 is started, as illustrated in FIG. 5.

In this way, the configuration in the connection unit 11 can be included in the ODD 2.

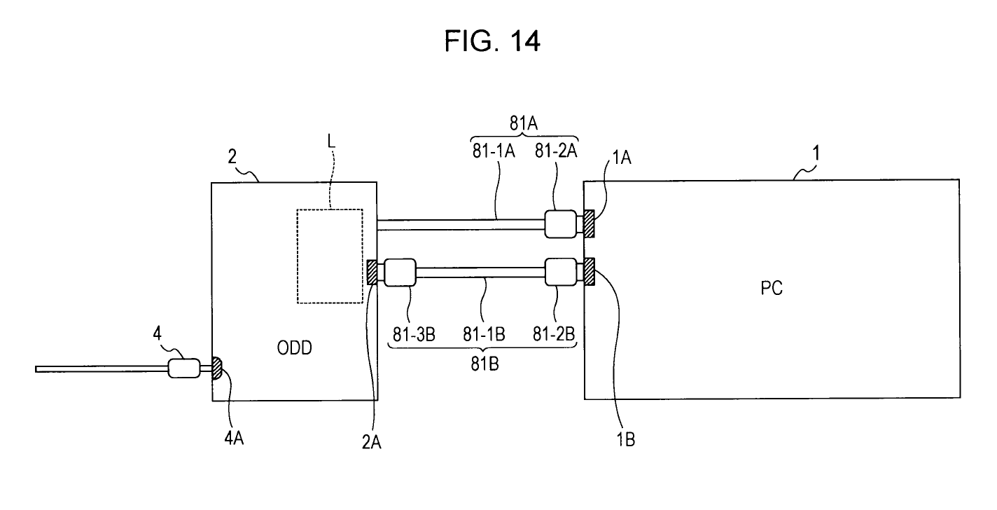

FIG. 14 illustrates an example of connection when an AC adaptor is connected.

The operation performed when, as shown in FIG. 12, the ODD 2 is connected to the PC 1 and if the DC plug 4 is plugged into a DC jack 4A of the ODD 2 is described next.

When the USB cables 81A and 81B are not connected to the PC 1 and if the DC plug 4 is plugged into the DC jack 4A of the ODD 2, electrical power necessary for the ODD 2 to operate is supplied from the AC adaptor. Upon detecting that the AC adaptor is connected, the USB IC 51 of the ODD 2 sets the mode of the ODD 2 to a self-powered mode.

When the USB cable 81A is connected to the PC 1, the USB IC 51 of the ODD 2 communicates with the USB IC 31A of the PC 1 via the signal line 61 and performs configuration setup and a variety of operations, such as data exchange, after the configuration setup is completed.

In this case, connection using the USB cable 81B is not necessary. Even when the ODD 2 is connected to the PC 1 using the USB cable 81B and if power is supplied from the PC 1 to the ODD 2, the switch circuit 41 continues to shut off the power.

In this way, since, during an operation in a self-powered mode, connection using the USB cable 81B is not necessary, only the USB cable 81A can be used as a cable for connecting the ODD 2 to the PC 1.

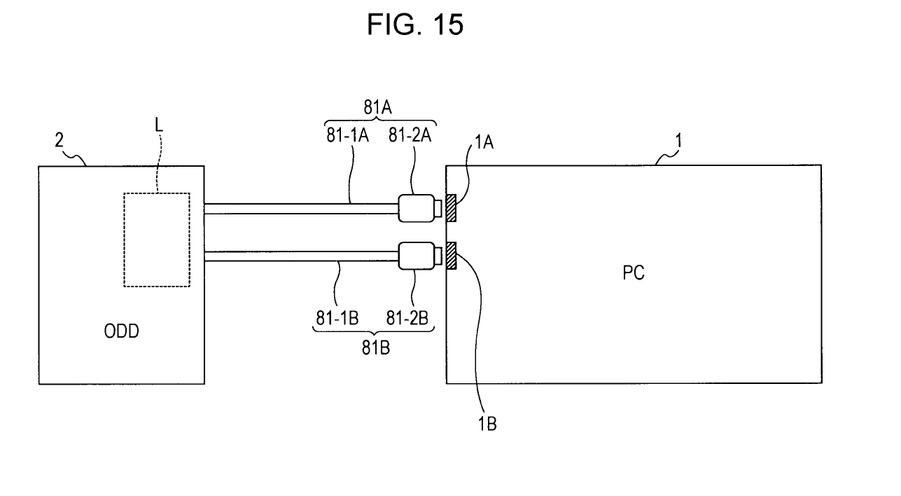

FIG. 15 illustrates another example of connection between the PC 1 and the ODD 2 using the USB cables 81A and 81B.

In the example shown in FIG. 15, each of the USB cables 81A and 81B is directly connected to the ODD 2. The USB cable 81A includes a cable 81-1A having one end being directly connected to the ODD 2 and a plug 81-2A attached to the top end of the cable 81-1A. The plug 81-2A is plugged into the USB port 1A of the PC 1. The USB cable 81B includes a cable 81-1B having one end being directly connected to the ODD 2 and a plug 81-2B attached to the top end of the cable 81-1B. The plug 81-2B is plugged into the USB port 1B of the PC 1.

Even when the ODD 2 is connected to the PC 1 as shown in FIG. 15, electrical connection among circuits is the same as that shown in FIG. 13.

### Second Embodiment

### Configuration of Each Unit

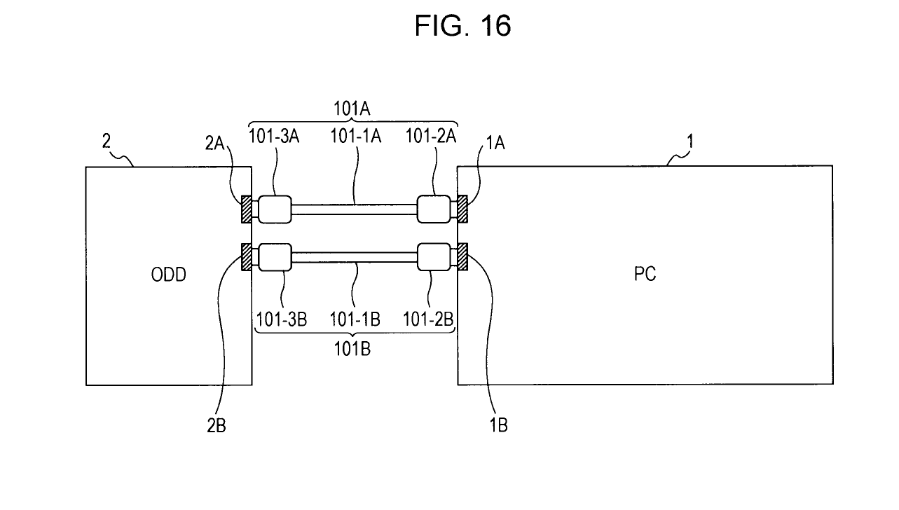

FIG. 16 illustrates an example of connection between the PC 1 and the ODD 2.

In the example shown in FIG. 16, the ODD 2 is connected to the PC 1 using USB cables 101A and 101B.

The USB cable 101A is formed from a cable 101-1A and plugs 101-2A and 101-3A attached to both ends of the cable 101-1A. The plug 101-2A is plugged into the USB port 1A of the PC 1, and the plug 101-3A is plugged into the USB port 2A of the ODD 2.

The USB cable 101B is formed from a cable 101-1B and plugs 101-2B and 101-3B attached to both ends of the cable 101-1B. The plug 101-2B is plugged into the USB port 1B of the PC 1, and the plug 101-3B is plugged into the USB port 2B of the ODD 2. In this example, the ODD 2 has two USB ports.

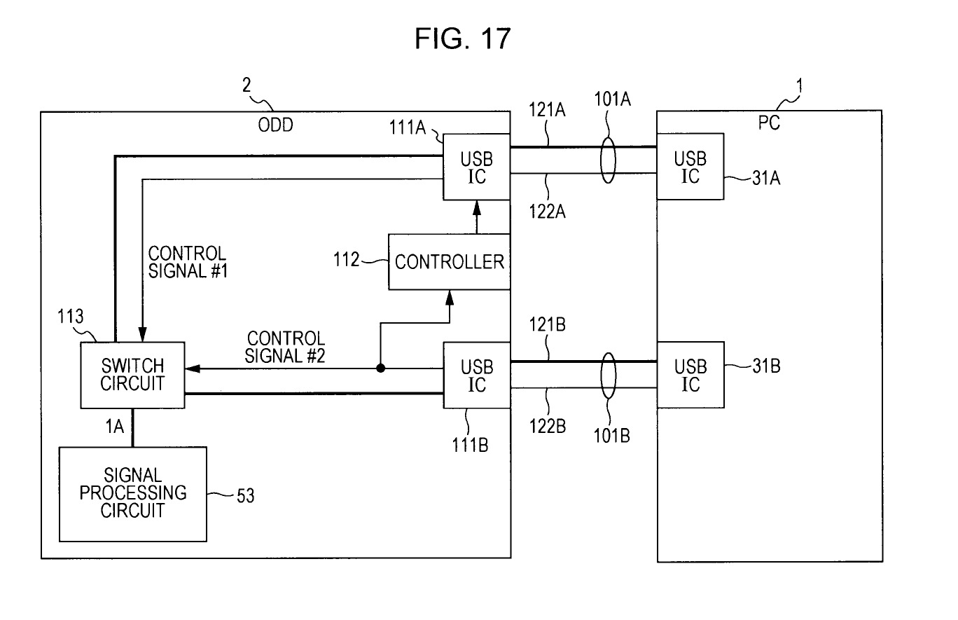

FIG. 17 illustrates an example of electrical connection between the PC 1 and the ODD 2 realized by using two cables, namely, the USB cables 101A and 102B as shown in FIG. 16.

The same numbering will be used in referring to a configuration shown in FIG. 17 as is utilized above in describing FIG. 3. Duplicate descriptions are not repeated as necessary.

As shown in FIG. 17, the ODD 2 includes a USB IC 111A that controls communication performed in the USB port 2A, a USB IC 111B that controls communication performed in the USB port 2B, a controller 112, a switch circuit 113, and a signal processing circuit 53.

When, as shown in FIG. 16, the ODD 2 is connected to the PC 1 using the USB cables 101A and 101B, the USB IC 31A of the PC 1 is connected to the USB IC 111A of the ODD 2 using a power supply line 121A and a signal line 122A that extend through the USB cable 101A. The USB IC 31A of the PC 1 functions as a host controller of the USB IC 111A of the ODD 2 connected using the signal line 122A. In contrast, the USB IC 111A of the ODD 2 functions as a target controller of the USB IC 31A of the PC 1.

In addition, the USB IC 31B of the PC 1 is connected to the USB IC 111B of the ODD 2 using a power supply line 121B and a signal line 122B that extend through the USB cable 101B. The USB IC 31B of the PC 1 functions as a host controller of the USB IC 111B of the ODD 2 connected using the signal line 122B. In contrast, the USB IC 111B of the ODD 2 functions as a target controller of the USB IC 31B of the PC 1.

The USB IC 111A supplies, to the switch circuit 113, an electric current supplied from the USB IC 31A of the PC 1 via the power supply line 121A. In addition, the USB IC 111A outputs a control signal #1 to the switch circuit 113 at a predetermined point in time.

The USB IC 111B supplies, to the switch circuit 113, an electric current supplied from the USB IC 31B of the PC 1 via the power supply line 121B. In addition, the USB IC 111B outputs a control signal #2 to the switch circuit 113 at a predetermined point in time. The control signal #2 output from the USB IC 111B is also supplied to the controller 112.

The controller 112 controls the operation performed by the USB IC 111A. Upon receiving the control signal #2 from the USB IC 111B, the controller 112 starts the operation of the USB IC 111A. That is, even when the USB cable 101A is connected, the operation of the USB IC 111A is inhibited until the control signal #2 is supplied from the controller 112.

The switch circuit 113 supplies, to the signal processing circuit 53, the electric current supplied from the USB IC 111A and the electric current supplied from the USB IC 111B together.

### Operation of Each Unit

The operation performed by each of the units connected as shown in FIG. 17 is described next.

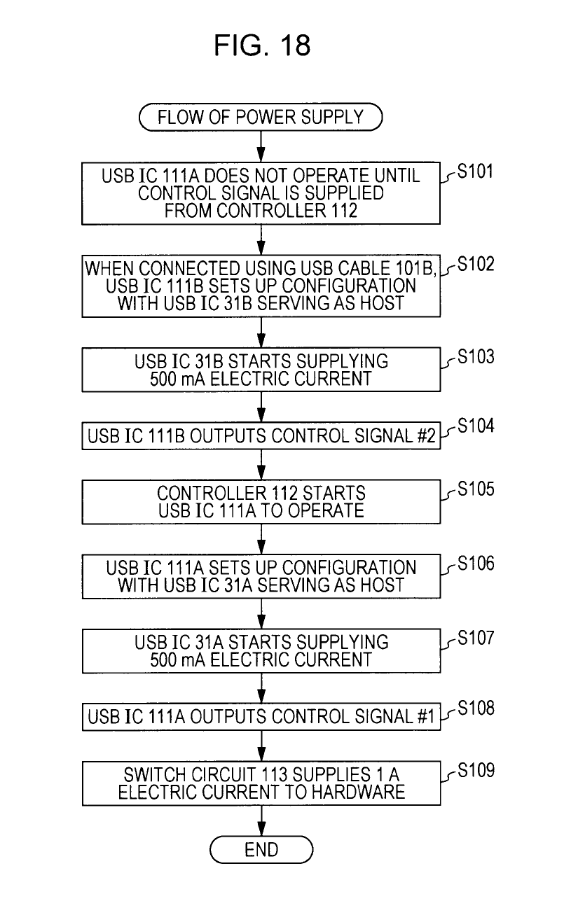

The operation performed when the plug 101-2A of the USB cable 101A is plugged into the USB port 1A of the PC 1 first and, thereafter, the plug 101-2B of the USB cable 101B is plugged into the USB port 1B of the PC 1 is described with reference to a flowchart shown in FIG. 18. Note that the plug 101-3A of the USB cable 101A has already been plugged into the USB port 2A of the ODD 2, and the plug 101-3B of the USB cable 101B has already been plugged into the USB port 2B of the ODD 2.

In step S101, when the ODD 2 is connected to the PC 1 using the USB cable 101A, the USB IC 111A does not operate until the control signal #2 is supplied from the controller 112.

In step S102, when the ODD 2 is connected to the PC 1 using the USB cable 101B, the USB IC 111B of the ODD 2 starts operating using a 100 mA electric current supplied from the USB IC 31B of the PC 1 via the power supply line 121B (an electric current before configuration setup is performed). By communicating with the USB IC 31B via the signal line 122B, the USB IC 111B performs configuration setup with the USB IC 31B, which is a host controller of the USB IC 111B.

When configuration setup with the USB IC 31B is completed and if the USB IC 31B recognizes that the USB IC 111B is a high-power bus powered device, the USB IC 31B of the PC 1 starts supplying a 500 mA electric current in step S103.

The 500 mA electric current supplied from the USE IC 31B of the PC 1 via the power supply line 121B is supplied to the USB IC 111B of the ODD 2 and is supplied to the switch circuit 113 via the USB IC 111B. The switch circuit 113 operates in a mode in which supply of an electric current is shut off until a control signal is received from each of the USB IC 111A and the USB IC 111B. Thus, at that point in time, the signal processing circuit 53 does not start operating.

In step S104, the USB IC 111B of the ODD 2 outputs a control signal #2.

In step S105, upon receiving the control signal #2 from the USB IC 111B, the controller 112 of the ODD 2 starts the USB IC 111A to operate. The USB IC 111A starts operating using the 100 mA electric current supplied from the USB IC 31A of the PC 1 via the power supply line 121A (an electric current before configuration setup is performed).

In step S106, by communicating with the USB IC 31A via the signal line 122A, the USB IC 111A performs configuration setup with the USB IC 31A, which is a host controller of the USB IC 111A.

When configuration setup with the USB IC 31A is completed and if the USB IC 31A recognizes that the USB IC 111A is a high-power bus powered device, the USB IC 31A starts supplying a 500 mA electric current in step S107. The 500 mA electric current supplied from the USB IC 31A of the PC 1 via the power supply line 121A is supplied to the USB IC 111A of the ODD 2 and is supplied to the switch circuit 113 via the USB IC 111A.

In step S108, the USB IC 111A of the ODD 2 outputs a control signal #1.

In step S109, when the control signal #2 is supplied from the USB IC 111B and if, subsequently, the control signal #1 is supplied from the USB IC 111A, the switch circuit 113 of the ODD 2 starts supplying power to the signal processing circuit 53. Thus, the signal processing circuit 53 receives a 500 mA electric current from each of the USB IC 31A and the USB IC 31B of the PC 1 (a 1 A electric current in total).

The signal processing circuit 53 starts operating using the 1 A electric current supplied from the switch circuit 113 and writes data on an optical disc or reads data from an optical disc. The data to be written to an optical disc is supplied from the USB IC 31A of the PC 1 via the signal line 122A to the USB IC 111A. Thereafter, the data is supplied to the signal processing circuit 53 via a signal line (not shown). In addition, the data read from an optical disc is supplied from the signal processing circuit 53 to the USB IC 111A via a signal line (not shown) and is supplied to the USB IC 31A of the PC 1 via the signal line 122A.

That is, in this example, like a widely used USB-connected ODD, the USB IC 111A operates as an MSC device. However, the USB IC 111B operates a device for receiving electrical power. The USB IC 31B of the PC 1 does not exchange data to be written to an optical disc and data read from an optical disc with the USB IC 111B of the ODD 2.

The above description has been made with reference to the operation performed when the ODD 2 is connected to the PC 1 using the USB cable 101A and, thereafter, the ODD 2 is connected to the PC 1 using the USB cable 101B. However, the same operation is performed when the ODD 2 is connected to the PC 1 using the USB cable 101B and, thereafter, the ODD 2 is connected to the PC 1 using the USB cable 101A.

In such a case, the process in step S101 is not performed. In addition, the process in step S106 is performed when the ODD 2 is connected to the PC 1 using the USB cable 101A after the process in step S104 in which the operation of the USB IC 111A is started is performed.

By connecting the ODD 2 to the PC 1 using the USB cables 101A and 101B in the above-described manner, the ODD 2 can receive a 500 mA electric current from each of the USB IC 31A and the USB IC 31B of the PC 1 (a 1 A electric current in total). Thus, the ODD 2 can stably operate.

In addition, since the switch circuit 113 functions as a “stopper”, any electric current is not supplied to the signal processing circuit 53 until the PC 1 starts supplying a 1 A electric current. In this way, the signal processing circuit 53 does not start operating in a state in which the electric current is unstable. Thus, the signal processing circuit 53 can reliably read and write data.

If the USB cable 101A complies with the USB 3.0 standard, the USB IC 111A may start operating regardless of whether the USB cable 101B is connected or not.

For example, if the ODD 2 is connected using the USB cable 101A that is USB 3.0 compliant, configuration setup is performed between the USB IC 111A of the ODD 2 and the USB IC 31A of the PC 1. When the configuration setup is completed, the USB IC 111A of the ODD 2 outputs, to the switch circuit 113, an electric current supplied from the USB IC 31A via the power supply line 121A. In addition, the USB IC 111A outputs a control signal #1. In this way, the USB IC 111A starts supply of an electric current to the signal processing circuit 53. In the USB 3.0 standard, when a host controller and a target controller support a super speed operation, a maximum of a 900 mA electric current can be supplied using one cable. By using a 900 mA electric current supplied via the USB cable 101A, the signal processing circuit 53 can be operated in an almost stable manner.

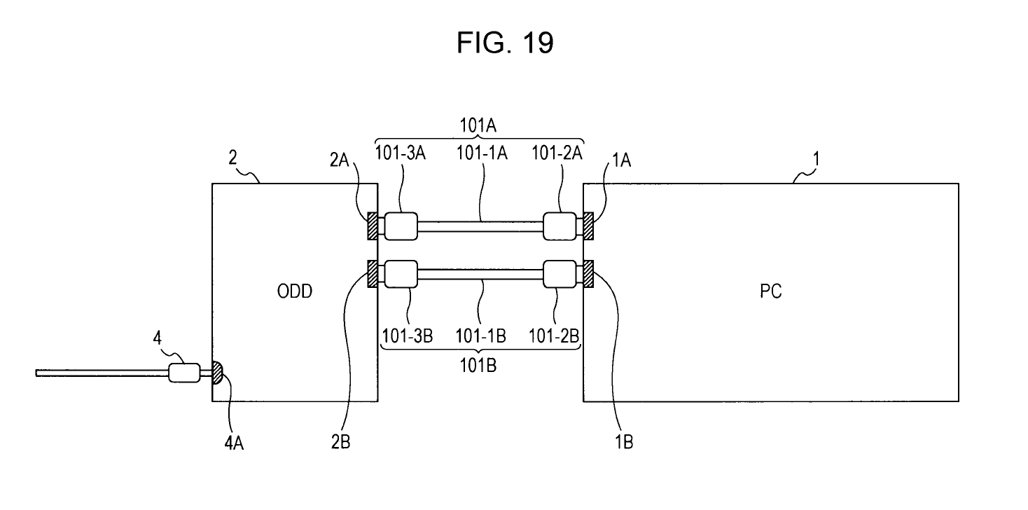

FIG. 19 illustrates an example of connection when the AC adaptor is used.

The operation performed when the ODD 2 is connected to the PC 1 as shown in FIG. 16 and if the DC plug 4 is plugged into a DC jack 4A of the ODD 2 is described next.

When the USB cables 101A and 101B are not connected to the PC 1 and if the DC plug 4 is plugged into the DC jack 4A of the ODD 2, electrical power necessary for the ODD 2 to operate is supplied. Upon detecting that the AC adaptor is connected, the USB IC 111A of the ODD 2 sets the mode of the ODD 2 to a self-powered mode.

When the USB cable 101A is connected to the PC 1, the USB IC 111A of the ODD 2 communicates with the USB IC 31A of the PC 1 via the signal line 122A and performs configuration setup and a variety of operations, such as data exchange, after the configuration setup is completed.

In this case, connection using the USB cable 101B is not necessary. Even when the ODD 2 is connected to the PC 1 using the USB cable 101B and if power is supplied from the PC 1 to the ODD 2, a shut-off circuit (not shown) provided in the ODD 2 shuts off the power supplied to a USB connector 2B.

In this way, since, during the operation in a self-powered mode, connection using the USB cable 101B is not necessary, only the USB cable 101A can be used as a cable for connecting the ODD 2 to the PC 1.

### Third Embodiment

### Configuration of Each Unit

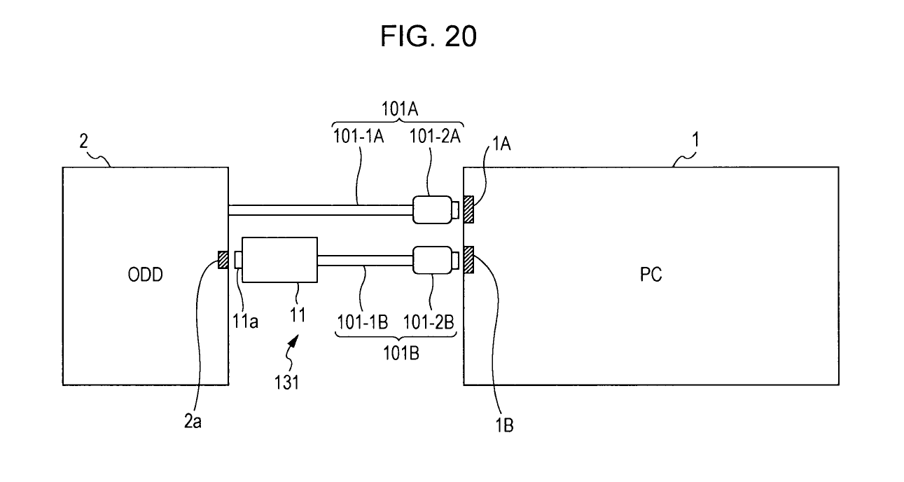

FIG. 20 illustrates an example of connection between the PC 1 and the ODD 2.

The same numbering will be used in referring to a configuration shown in FIG. 20 as is utilized in the above-described configuration. In the example shown in FIG. 20, the ODD 2 is connected to the PC 1 using a USB cable 101A and a connection cable 131.

The USB cable 101A is formed from a cable 101-1A having one end directly connected to the ODD 2 and a plug 101-2A attached to the top end of the cable 101-1A. The plug 101-2A is plugged into the USB port 1A of the PC 1.

The connection cable 131 includes a connection unit 11 and a cable 101B. The connection unit 11 has a connector 11a, which is plugged into a connector port 2a of the ODD 2. The cable 101B is formed from the cable 101-1B directly connected to the connection unit 11 and the plug 101-2B provided to the top of the cable 101-1B. The plug 101-2B is plugged into the USB port 1B of the PC 1.

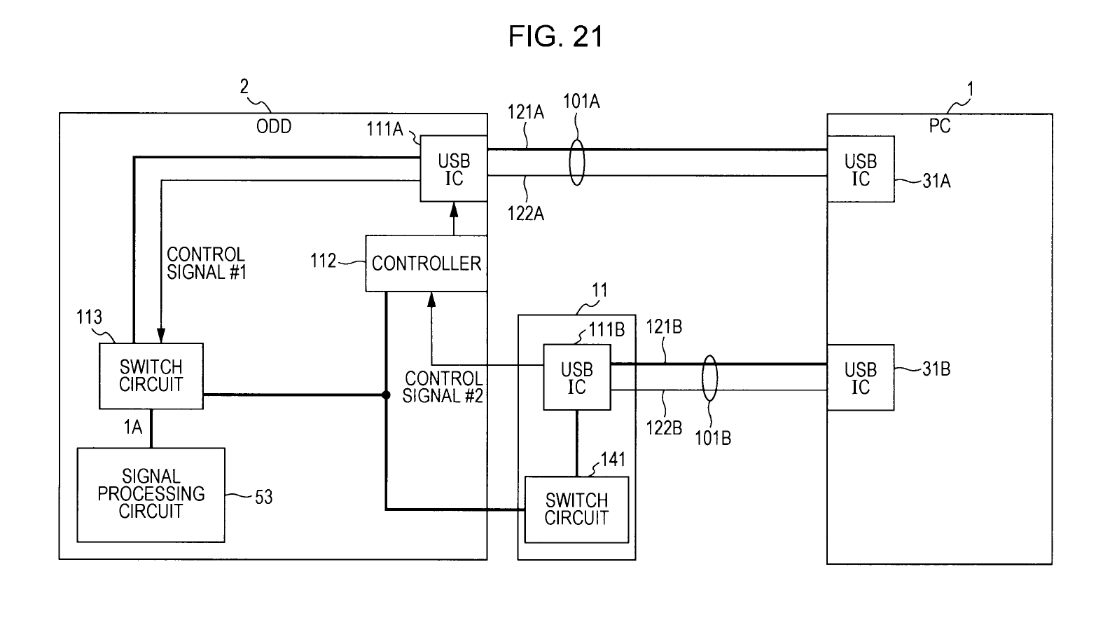

FIG. 21 illustrates an example of electrical connection between the PC 1 and the ODD 2 realized by using two cables, namely, the USB cables 101A and the connection cable 131 as shown in FIG. 20.

The same numbering will be used in referring to a configuration shown in FIG. 21 as is utilized above in describing FIG. 17. Duplicate descriptions are not repeated as necessary.

As shown in FIG. 21, the connection unit 11 includes the USB IC 111B, which is provided to the ODD 2 in FIG. 17. In addition, a switch circuit 141 is provided in the connection unit 11.

When the ODD 2 is connected to the PC 1 using the USB cable 101A, the USB IC 31A of the PC 1 is connected to the USB IC 111A of the ODD 2 via the power supply line 121A and the signal line 122A that extend through the USB cable 101A. The USB IC 31A of the PC 1 functions as a host controller of the USB IC 111A of the ODD 2 connected using the signal line 122A. In contrast, the USB IC 111A of the ODD 2 functions as a target controller of the USB IC 31A of the PC 1.

In addition, when the ODD 2 is connected to the PC 1 using the connection cable 131, the USB IC 31B of the PC 1 is connected to the USB IC 111B of the connection unit 11 by the power supply line 121B and the signal line 122B that extend through the USB cable 101B. The USB IC 31B of the PC 1 operates as a host controller for the USB IC 111B of the connection unit 11 connected via the signal line 122B. In contrast, the USB IC 111B of the connection unit 11 operates as a target controller for the USB IC 31B of the PC 1.

The USB IC 111A of the ODD 2 supplies, to the switch circuit 113, an electric current supplied from the USB IC 31A of the PC 1 via the power supply line 121A. In addition, the USB IC 111A outputs the control signal #1 to the switch circuit 113 when configuration setup between the USB IC 111A and the USB IC 31A of the PC 1 is completed.

The USB IC 111B of the connection unit 11 supplies, to the switch circuit 141, an electric current supplied from the USB IC 31B of the PC 1 via the power supply line 121B. In addition, the USB IC 111B outputs the control signal #2 to the controller 112 of the ODD 2 when configuration setup between the USB IC 111B and the USB IC 31B of the PC 1 is completed.

The switch circuit 141 of the connection unit 11 supplies, to the ODD 2, an electric current supplied from the USB IC 111B. The electric current supplied from the switch circuit 141 branches in the ODD 2 and is supplied to the controller 112 and the switch circuit 113.

The controller 112 operates using electrical power supplied from the switch circuit 141 and controls the operation of the USB IC 111A. Upon receiving the control signal #2 from the USB IC 111B, the controller 112 starts the USB IC 111A to operate. That is, even when the USB cable 101A is connected, the operation of the USB IC 111A is inhibited until the control signal #2 is supplied from the switch circuit 141 of the connection unit 11 to the controller 112.

Upon receiving the control signal #1 from the USB IC 111A, the switch circuit 113 of the ODD 2 supplies the electric current supplied from the USB IC 111A and the electric current supplied from the switch circuit 141 of the connection unit 11 to the signal processing circuit 53. When the USB IC 111A completes configuration setup and if the USB IC 111B completes configuration setup, each of the USB IC 111A and the switch circuit 141 of the connection unit 11 supplies a 500 mA electric current to the switch circuit 113. The switch circuit 113 sums these electric currents and supplies a 1 A electric current to the signal processing circuit 53.

### Other Embodiments

Each of the ODDs 2 having the above-described configurations may support a USB charge AC adaptor.

A USB charge AC adaptor is used for charging, for example, a portable device, such as a music player or a cell phone. The USB charge AC adaptor receives an electric current from an electric outlet and supplies the electric current to a device to be charged via a USB cable. A USB cable attached to a USB charge AC adaptor has an A plug and supplies, for example, 5 V power via a VBUS line of the A plug.

A USB cable attached to a USB charge AC adaptor includes a signal line and a power supply line. A USB charge AC adaptor does not function like a USB host controller. However, a device having a USB charge AC adaptor connected thereto can recognize that an adaptor is connected rather than a normal USB host controller by determining the state of the signal line.

The USB IC 42 and the USB IC 111B can be connected to such a USB charge AC adaptor. In such a case, for example, the USB IC 42 operates as follows.

That is, when a USB charge AC adaptor is connected and the power is supplied from the USB charge AC adaptor via the power supply line, the USB IC 42 recognizes that it is connected to a USB charge AC adaptor. The USB IC 42 supplies, to the switch circuit 41, a control signal indicating that the power supplied from the USB charge AC adaptor is available. Thereafter, for example, the processes subsequent to step S5 shown in FIG. 4 are performed by a variety of circuits excluding the USB IC 42.

Since demand for charging methods using a USB cable has been increasing, USB-IF (USB Implementers Forum, Inc.) has established the standard “Battery Charging Specification Rev. 1.1 Apr. 15, 2009”. By additionally providing, to the USB IC 42, a function of recognizing a USB charger according to the standard, the USB IC 42 can operate in the above-described manner when a USB charge AC adaptor is connected.

Although the present disclosure has been described in conjunction with above embodiments thereof, it is evident that various modifications can be made within the spirit and broad scope of the disclosure. For example, all of the USB cables directly connected to the ODD 2 or the connection unit 11 can be made removable.

While the above description has been made with reference to the case in which the USB controller provided in the PC 1, the ODD 2, or the connection unit 11 of the Y cable 3 serves as a controller that complies with the USB 2.0 standard, the USB controller may be a controller that complies with the USB 3.0 standard. If these USB controllers support a Super Speed operation of the USB 3.0 standard, an electric current supplied from the PC 1 before configuration setup is performed is 150 mA, and an electric current supplied from the PC 1 after configuration setup has been performed is 900 mA.

The present disclosure contains subject matter related to that disclosed in Japanese Priority Patent Application JP 2010-142865 filed in the Japan Patent Office on Jun. 23, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A power supply circuit connected to an information processing apparatus including a first controller and a second controller via a first cable including a first signal line and a first power supply line and a second cable including a second signal line and a second power supply line, the circuit comprising:
a control circuit configured to start operating using an electric current of a first level supplied from the information processing apparatus via the second power supply line and set up settings of the operation by communicating with the second controller via the second signal line; and
a switch circuit configured to supply, to a controller of an external device, the electric current supplied from the information processing apparatus via the first power supply line and an electric current supplied from the second power supply line when the setup of settings of the operation of the control circuit is completed;
wherein when setup of settings of an operation of the controller of the external device is completed through communication between the controller of the external device that has started operating when receiving the electric current and the first controller via the first signal line, the switch circuit supplies, to the controller of the external device, an electrical current of a second level that is higher than the first level supplied from the information processing apparatus via each of the first power supply line and the second power supply line together.

2. The power supply circuit according to claim 1, wherein each of the first cable and the second cable is a USB compliant cable.

3. The power supply circuit according to claim 2, wherein when the first and second controllers of the information processing apparatus, the control circuit, and the controller of the external device are USB controllers that comply with the USB 2.0 standard, the first level is 100 mA and the second level is 500 mA, and wherein when the first and second controllers of the information processing apparatus, the control circuit, and the controller of the external device are USB controllers that comply with USB 3.0 Super Speed standard, the first level is 150 mA and the second level is 900 mA.

4. The power supply circuit according to claim 1, wherein the power supply circuit is provided outside the external device, and wherein a third cable including the first signal line and a third power supply line used by the switch circuit to supply electrical power is further connected to the power supply circuit.

5. A power supply method for use in a power supply circuit, the power supply circuit connected to an information processing apparatus including a first controller and a second controller via a first cable including a first signal line and a first power supply line and a second cable including a second signal line and a second power supply line, the power supply circuit including a control circuit configured to start operating using an electric current of a first level supplied from the information processing apparatus via the second power supply line and set up settings of the operation by communicating with the second controller via the second signal line and a switch circuit configured to supply, to a controller of an external device, an electric current supplied from the information processing apparatus via the first power supply line and the second power supply line when the setup of settings of the operation of the control circuit is completed, the method comprising:
when setup of settings of an operation of the controller of the external device is completed through communication between the controller of the external device that has started operating when receiving the electric current and the first controller via the first signal line, supplying, from the switch circuit to the controller of the external device, an electrical current of a second level that is higher than the first level supplied from the information processing apparatus via each of the first power supply line and the second power supply line together.

6. A signal processing apparatus connected to an information processing apparatus including a first controller and a second controller via a first cable including a first signal line and a first power supply line and a second cable including a second signal line and a second power supply line, the signal processing apparatus comprising:
a first control circuit connected to the first controller via the first signal line;
a second control circuit configured to start operating using an electric current of a first level supplied from the information processing apparatus via the second power supply line and set up settings of the operation by communicating with the second controller via the second signal line;
a switch circuit configured to supply, to the first control circuit, electric currents supplied from the information processing apparatus via the first power supply line and the second power supply line when the setup of settings of the operation of the second control circuit is completed; and
a signal processing circuit configured to operate using the electric currents supplied to the first control circuit;
wherein the first control circuit starts operating using the electric currents supplied from the switch circuit and sets up settings of the operation through communication with the first controller via the first signal line, and wherein when setup of the settings of the operation of the first control circuit is completed, the switch circuit supplies, to the first control circuit, an electrical current of a second level that is higher than the first level supplied via each of the first power supply line and the second power supply line together.

7. The signal processing apparatus according to claim 6, wherein the first control circuit communicates with the first controller via the first signal line and receives data transmitted from the first controller and to be processed by the signal processing circuit, and wherein the first control circuit transmits the data processed by the signal processing circuit to the first controller.

8. A power supply method for use in a signal processing apparatus, the signal processing apparatus being connected to an information processing apparatus including a first controller and a second controller via a first cable including a first signal line and a first power supply line and a second cable including a second signal line and a second power supply line, the signal processing apparatus including a first control circuit connected to the first controller via the first signal line, a second control circuit configured to start operating using an electric current of a first level supplied from the information processing apparatus via the second power supply line and set up settings of the operation by communicating with the second controller via the second signal line, a switch circuit configured to supply, to the first control circuit, electric currents supplied from the information processing apparatus via the first power supply line and the second power supply line when the setup of settings of the operation of the second control circuit is completed, and a signal processing circuit configured to operate using the electric currents supplied to the first control circuit, the method comprising:
starting the first control circuit to operate using the electric currents supplied from the switch circuit and set up the operation through communication with the first controller via the first signal line; and
when setup of the settings of the operation of the first control circuit is completed, supplying, from the switch circuit to the first control circuit, an electrical current of a second level that is higher than the first level via each of the first power supply line and the second power supply line together.

9. A signal processing apparatus connected to an information processing apparatus including a first controller and a second controller via a first cable including a first signal line and a first power supply line and a second cable including a second signal line and a second power supply line, the signal processing apparatus comprising:
a first control circuit connected to the first controller via the first signal line, the first control circuit operating using an electric current supplied from the information processing apparatus via the first power supply line;
a second control circuit configured to start operating using an electric current of a first level supplied from the information processing apparatus via the second power supply line and set up settings of the operation by communicating with the second controller via the second signal line;
a switch circuit configured to output electric currents supplied from the information processing apparatus via the first power supply line and the second power supply line; and
a signal processing circuit configured to operate using the electric currents supplied from the switch circuit;
wherein when setup of settings of the operation of the second control circuit is completed, the first control circuit starts operating using the electric current supplied from the information processing apparatus via the first power supply line and sets up settings of the operation through communication with the first controller via the first signal line, and wherein when setup of the settings of the operation of the first control circuit is completed, the switch circuit outputs an electric current of a second level higher than the first level that is supplied from the information processing apparatus via the first power supply line and an electrical current of the second level that is supplied from the information processing apparatus via the second power supply line together.

10. The signal processing apparatus according to claim 9, wherein the first control circuit communicates with the first controller via the first signal line and receives data transmitted from the first controller and to be processed by the signal processing circuit, and wherein the first control circuit transmits the data processed by the signal processing circuit to the first controller.

11. A power supply method for use in a signal processing apparatus connected to an information processing apparatus including a first controller and a second controller via a first cable including a first signal line and a first power supply line and a second cable including a second signal line and a second power supply line, the signal processing apparatus including a first control circuit connected to the first controller via the first signal line and operating using an electric current supplied from the information processing apparatus via the first power supply line, a second control circuit configured to start operating using an electric current of a first level supplied from the information processing apparatus via the second power supply line and set up settings of the operation by communicating with the second controller via the second signal line, a switch circuit configured to output the electric currents supplied from the information processing apparatus via the first power supply line and the second power supply line, and a signal processing circuit configured to operate using the electric currents supplied from the switch circuit, the method comprising:
when setup of settings of the operation of the second control circuit is completed, starting the first control circuit to operate using the electric current supplied from the information processing apparatus via the first power supply line and set up the operation through communication with the first controller via the first signal line; and
when setup of the settings of the operation of the first control circuit is completed, outputting, from the switch circuit, an electric current of a second level higher than the first level that is supplied from the information processing apparatus via the first power supply line and an electrical current of the second level that is supplied from the information processing apparatus via the second power supply line together.
